(19) United States
(12) Patent Application Publication
(10) Pub. No.: US 2018/0340571 A1
(43) Pub. Date: Nov. 29, 2018

(54) BEARING ASSEMBLY

(71) Applicant: Airbus Operations Limited, Bristol (GB)

(72) Inventor: Meher Sriram AYYAGARI, Bristol (GB)

(21) Appl. No.: 15/983,734

(22) Filed: May 18, 2018

(30) Foreign Application Priority Data
May 23, 2017 (GB) 1708259.5

(51) Int. Cl. F16C 33/14; F16C 17/02

(52) U.S. Cl. CPC F16C 33/14; B64C 9/02; F16C 2326/43; F16C 17/02

(57) ABSTRACT

A bearing assembly 1 for installation in a through-hole 10 in a composite material 8 is disclosed having a first bush 2a and a second bush 2b, each of the first and second bushes 2 having a flange 6, the first and second bushes 2 being held together such that, in use, when the bearing assembly 1 is installed in the through-hole 10 with the flanges 6 of the first and second bushes 2 on opposite sides of the material 8 the flanges 6 limit the axial movement of the bushes 2 relative to the through-hole 10.

### CROSS RELATED APPLICATION

This application claims priority to the United Kingdom patent application GB 1708259.5 filed May 23, 2017, the entirety of which is incorporated by reference.

### BACKGROUND OF THE INVENTION

The present disclosure relates to bearing installation in composite materials. More particularly, but not exclusively, this invention concerns a bearing assembly for use in a through-hole in a composite material, a composite material, aircraft assembly, or aircraft including such a bearing assembly, a kit of parts for such a bearing assembly, a method of installing such a bearing assembly and a method of maintaining such a bearing assembly.

It is known to install a bearing in a through-hole formed in a metallic aircraft structure using a press-fit. That is to say, by exerting sufficient force on the bearing to force it into the hole and form an interference fit between the bearing and the hole. One application for such a bearing is in mounting a spoiler to an aircraft wing. A spoiler is mounted to a wing via two or more lugs, each lug having a through-hole with a spherical bearing (i.e. a bearing that permits angular rotation about a central point in two orthogonal directions) received therein. A pin connected to the spoiler is received in the central recess of the bearing, thereby allowing the spoiler to move relative to the wing structure.

Increasingly, composite materials, such as carbon fibre composites, are being used in aircraft as they may offer a weight saving as compared to metal. However, the force required to push fit a bearing into a through-hole in a composite material, or remove a bearing so installed during servicing, may lead to delamination or other damage of the composite. If less force is used to reduce the risk of damage then the risk of the bearing migrating is increased. It would be advantageous to provide a method of installing a bearing in a composite material that reduces the risk of damage to the composite structure and/or that reduces the risk of migration.

A possible method of bearing installation is to bond the bearing to the composite in situ. However it is difficult to ensure a consistent quality of such bonding is achieved, and in-service replacement is difficult when a sealant is used. It would be advantageous to provide a method of installing a bearing in a composite material that allows for easier in-service removal and replacement of the bearing.

The present invention seeks to mitigate one or more of the above-mentioned problems. Alternatively or additionally, the present invention seeks to provide an improved method for bearing installation at low cost, without introducing significant mechanical complexity and while using off the shelf standard parts where possible.

### SUMMARY OF THE INVENTION

The present invention provides, according to a first aspect, a bearing assembly for installation in a through-hole in a composite material, the bearing assembly comprising a first bush (also known as bushing) and a second bush, each of the first and second bushes having a flange, the first and second bushes being fixed together such that, in use, when the bearing is installed in the through-hole with the flanges of the first and second bushes on opposite sides of the material both flanges act together to limit the axial movement of the bushes relative to the through-hole. Providing two separate bushings with a flange at either end facilitates installation of the bearing while avoiding the need to create an interference fit with the through-hole and thereby risking damage to the composite material; the bushings can be inserted into the through-hole from either end and then fixed together in situ, so the flange at either end of the assembled bearing holds the bearing in the through-hole. The use of the flanges may also allow the axial load transmitted to the aircraft via the bearing assembly to be distributed over a wider area of the composite material, thereby reducing the risk of damage. The flanges may also reduce the risk of axial bearing migration occurring during the service life of the assembly.

The first bush and the second bush may be fixed together directly or indirectly to resist axial movement of the first and second bushes relative to each other (e.g. along the longitudinal axis of a through-hole).

Each bush may have a main body with a flange extending from one end thereof. The flange may be located in a region adjacent a first end of a bush. The flange may be located at the first end of the bush. The flange may extend around the majority of, for example the whole of, the perimeter of the body in the region of the first end. The flange may extend radially outward from the main body. The flanges on the bushes may be sized and shaped such that the flange cannot pass through the through-hole.

The main body of a bush may comprise a recess. The main body may be tubular. The tubular body may have a substantially circular cross-section. The tubular body may have an inner surface and an outer surface. In use, the inner surface of the tubular body may form a bearing surface for a component mounted using the bearing assembly. The main body of the first and second bush may have a substantially similar, for example the same internal diameter. The main body of the first and second bush may have a substantially similar, for example the same, outer diameter. Alternatively, the inner and/or outer diameter of the first and second bush may differ such that at least a portion of one of the first and second bush can be located inside the other of the first and second bush. The first and second bush may be shaped and sized such that a portion of the main body of one of the first and second bush, for example the majority of the main body of one of the first and second bush, can fit inside the main body of the other or the first and second bush.

The composite material may have a first side, and a second side opposite the first side. The through-hole may extend through the depth of the composite material from one side of the composite material to the other. The through-hole may be defined by an inner surface of composite material. The through-hole may have a substantially circular cross-section along the majority of its length. The composite material may have a first, outward facing, surface on the first side. The composite material may have a second, outward facing, surface on the second side. It may be that a counter-bore is formed in the first and/or second surface co-axial with the through-hole. A counter-bore may be defined as a recess that enlarges another co-axial hole, in particular a recess in which the majority of the bottom surface of the recess is flat. The or each counter-bore may be configured to receive the flange of a bush element. The depth of the counter-bore may be such that the outer-surface of a flange received therein is substantially flush with the outer surface of the composite material adjacent the counter-bore.

The bearing assembly may further comprise a sleeve. The sleeve may be configured, for example sized and shaped, to provide an interference fit with an internal surface of each of the first and second bushes. Thus, the sleeve may hold the first and second bushes together by forming an interference fit with each of the bushes. It will be appreciated that an interference fit refers to a fastening achieved by friction after the bushes are pushed together, rather than by any other means of fit. The sleeve may be configured to provide a minimum interference of at least 1 μm, for example at least 5 μm, for at least 10 μm with the first and second bushes. The sleeve may be configured to provide a maximum interference of less than 50 μm, for example less than 45 μm with the first and second bushes.

The sleeve may be tubular. The sleeve may have a substantially circular cross-section. In the case that each bush has a tubular body, the sleeve may be received within the tubular body such that the outer surface of the sleeve is adjacent to the inner surface of the tubular body. The outer surface of the sleeve may therefore form a frictional engagement with the inner surface of each of the first and second bushes. The length of the sleeve may be greater than the combined length of the first bush and the second bush when placed end to end. Thus, in use, the sleeve may extend through the first bush and through the second bush and out either side. The length of the sleeve may be greater than the length (i.e. depth) of the through-hole.

At least one of the first or second bushes may comprise an interlock feature. The interlock feature may be configured such that rotation of the first and second bushes relative to each other causes the interlock feature to engage with the other of the first or second bushes to limit axial movement of the first and second bushes relative to each other. It may be that both the first and second bushes comprise complementary interlock features. In which case, the interlock feature of the first bush may engage the interlock feature of the second bush. Or it may be that only one of the first and second bushes comprise an interlock feature. In which case, the interlock feature of the first or second bush may engage with a portion of the other of the first and second bush. The interlock feature(s) may provide a mechanical lock between the first and second bushes such that, when the interlocking features are engaged, axial movement of the first and second bushes relative to each other is limited, for example prevented.

The interlock feature may comprise a screw thread extending around a portion of the surface of the bush such that rotation of the first and second bushes relative to each other causes the first and second bushes to be screwed together. The screw thread may extend around a portion of the outer surface of the bush or the inner surface of the bush. It may be that one of the first and second bush comprises a male screw thread (e.g. a thread protruding from the surface of the bush). It may be that the other of the first and second bush comprises a female screw thread (e.g. a thread recessed into the surface of the bush). The male screw thread may extend over one of the inner surface and the outer surface of the bush and the female screw thread (if present) may extend over the other one of the inner surface and the outer surface of the bush. The screw thread may extend along the majority of the length of the bush. The screw thread may extend along the majority of the length of the main body of the bush. An end of one of the first and second bushes, for example the end of the bush opposite the flange, may comprise self-tapping features. For example the first or second bush may comprise an edge configured to cut into the material of the other of the first and second bush. The first or second bush may comprise a groove (also known as a flute) configured to allow material cut by the edge to escape. Thus, the screw thread of the first and/or second bush may be self-tapping. A screw-thread may provide a simple yet secure means of fixing the first and second bushes together.

The female interlock feature may comprise an interlock recess, for example a recess extending inwards from the second (non-flanged) end of the bush. The male interlock feature may comprise a projection, for example a projection extending outwards from the second (non-flanged) end of the bush. The female interlock feature may comprise a recess configured to receive the projection therein. The recess and projection may be shaped such that rotation of the first and second bush relative to each other causes the projection to move relative to the recess from an unengaged position in which axial movement of the first and second bushes is possible, to an engaged position in which axial movement of the first and second bushes relative to each other is limited, for example prevented.

The projection may comprise one or more arms extending therefrom. The interlock recess may comprise a main recess and at least one sub-recess adjoining the main recess. The main recess may be configured to receive the projection and arms (if present) therein. The sub-recess may be configured to receive an arm when the projection is located in the main recess. The first and second bushes may be configured such the projection and one or more arms can be inserted into the main recess, and subsequent rotation of the first and second bushes relative to each other causes an arm to enter a sub-recess, thereby bringing the projection into engagement with the recess. A portion of the projection and/or arm (if present) may contact, for example directly contact, the structure defining the recess (or sub-recess if present) when the projection and/or arm is in the engaged position.

An interlock feature, for example the projection or arm (if present) may comprise a resilient portion, such that rotation of the first and second bushes relative to each other between the engaged and disengaged configuration causes or requires a deformation of the resilient portion. The resilient portion may be configured to resist engagement and/or disengagement of the first and second bushes. For example, it may be necessary to deform the resilient portion to engage and/or disengage the first and second bushes. The bushes may be configured such that the resilient portion is in a first (original) configuration when the first and second bushes are both engaged and disengaged. In this case, the resilient portion may have a second (deformed) configuration when the first and second bushes are at an intermediate position between the engaged and disengaged positions. Alternatively, the bushes may be configured such that the resilient portion is in a first configuration with the first and second bushes are disengaged and a second, different (deformed) configuration when the first and second bushes are engaged. In the case that the interlock feature requires an arm or a projection the recess may be configured such that the arm or a portion of the projection is displaced by contact with a side wall of the recess as the bushes move between the engaged and disengaged configuration. The projection or arm may form a detent located on one of the first and second bush configured to engage a corresponding feature (for example a lip, a tooth or other portion of a surface defining a recess) on the other of the first and second bushes. The detent may resist disengagement (unlocking) of the bushes as a result of this engagement. The interlock feature may be resilient such that the male and/or female feature returns to its original shape when the bushes are disengaged.

At least one of the first and second bush may comprise a radially extending tab. The tab may extend from the perimeter of a flange. The tab may be configured to be received in a corresponding recess in the surface of the composite material to prevent rotation of the bush relative to the composite material.

The first and/or second bushes may be made from plastic or metal, for example steel, titanium or aluminium or alloys of any one of those metals.

The sleeve may be made from metal, for example aluminium, steel, titanium or alloys of any one of those metals.

The composite material may comprise a reinforcing fibre such as carbon or glass fibre embedded in a matrix. The composite material may comprise one or more plies of fibre material in which the fibres of each ply extend in a predetermined orientation with respect to the fibres on the other plies. The matrix material may be a thermoplastic material or a thermosetting material, for example an epoxy resin.

The composite material may form a lug. A lug may be defined as a projection on a structure, the projection being configured to allow mounting for another component. A through-hole may extend from one side of the lug to another. Thus, the lug may be made from the composite material, and the bearing assembly of the present invention may be mounted in the lug. The structure from which the lug projects may be an aircraft structure. The structure of which the lug is part may form part of a wing assembly, rudder assembly or the fuselage of an aircraft. The structure may be a wing rib or spar on an aircraft.

According to a second aspect of the invention there is also provided a portion of composite material having a through-hole formed therein and a bearing assembly installed in said through-hole, the bearing assembly comprising a first bush and a second bush, each of the first and second bushes having a flange, and wherein a portion of each bush is located in the through-hole with the flange of one of the first and second bushes on one side of the composite material and the flange of the other one of the first and second bushes on the other side of the composite material, the first and second bushes being fixed together such that the flanges together limit axial movement of the first and second bushes relative to the through-hole.

The flanges on the bushes may be sized and shaped such that the flange cannot pass through the through-hole. Thus, by having a flange on either side of the through-hole and the two bushes joined together, axial movement of the bearing in the through-hole can be reduced or prevented. A portion of the main body of the bush, for example the majority of the main body, for example the whole of the main body of the bush may be received in the through-hole. Thus, the bush may be mounted in the through-hole with its main body in the hole and the flange resting on the surface of the composite material. When the bush is mounted in the through-hole, the tab (discussed above) may be received in a corresponding recess in the outer surface of the composite material.

The outer surface of the body of a bush may be adjacent to, for example in contact with, the inner surface of the through-hole. When installed in the through-hole, each bush may have an inner end and an outer end, the inner end of the bush being located closer to the centre of the through-hole than the outer end. The inner ends of the first and second bushes may be adjacent to each other, for example in an abutting relationship. Each outer end may have an outer face. The outer face may comprise the outer surface of the flange.

The first and/or second bushes may be configured, for example sized and shaped, to provide a clearance fit with the through-hole. The first and or second bushes may be configured, for example sized and shaped, to provide a transition fit. The first and second bushes may be configured to provide a maximum clearance of more than 10 μm, for example more than 50 μm, for example more than 100 μm. In some embodiments, the first and/or second bushes may be configured, for example sized and shaped to provide an interference fit with the through-hole. The first and second bushes may be configured to provide a minimum clearance of at least 1 μm, for example at least 5 μm, for example at least 10 μm with the inner surface of the through-hole. The first and second bushes may be configured to provide a maximum clearance of less than 50 μm, for example less than 40 μm with the inner surface of the through-hole.

It may be that a sleeve is mounted within and extends through the first and second bushes. A portion of the sleeve may extend beyond the outer surface of the bushes and/or the composite material on each side of the composite material.

In use, the sleeve may comprise a lip that extends across a portion of the outer face of a bush, for example the outer face of the flange, when the sleeve is mounted therein. In use, the sleeve may comprise a lip at each end of the sleeve. By extending across the ends of both bushes, the rim may act to hold the bushes together, and prevent axial movement of the bushes relative to each other. The or each rim may be formed after the sleeve has been inserted into the bushes, as discussed in more detail below.

The bearing assembly may further comprise a moving element bearing, for example a roller bearing or a spherical bearing. The moving element bearing may be mounted inside the sleeve. In use, the sleeve may comprise a rim at each end that extends across a portion of the outer surface of the adjacent bearing. Thus the rim may extend in both radial directions; outward over the moving element bearing and inwards over a bush. Alternatively, in the case that the bearing assembly does not include a sleeve the moving element bearing may be mounted directly inside the first and second bushes.

The bearing assembly may comprise further bearing elements, for example one or more internal bushes mounted inside the sleeve (if present) or the moving element bearing (if present).

In a third aspect of the invention there is provided an aircraft assembly comprising a control surface mounted for movement relative to the aircraft assembly using a bearing assembly in accordance with any other aspect. The bearing assembly may be received in a through-hole in a lug forming part of an aircraft assembly. The control surface may be an aileron, elevator, rudder, spoiler, flap, slat, air-break or any other form of control surface. The aircraft assembly may be a wing assembly or tail assembly of an aircraft.

The control surface may comprise a rod that, in use, is mounted on the bearing assembly, for example received within a recess of the bearing assembly. The rod may be in contact with any one of: the inner surface of the first and second bushes, the inner surface of a sleeve mounted in the first and second bushes (if present), an inner surface of the moving element bearing mounted in the sleeve (if present), an inner surface of one or more further element bearings mounted in the sleeve or the moving element bearing (if present). Thus, any one of those surfaces may form a bearing surface.

In a fourth aspect of the invention there is provided an aircraft comprising an aircraft assembly in accordance with any other aspect. The aircraft may be a commercial aircraft, for example a commercial passenger aircraft. The aircraft may be capable of transporting more than fifty passengers, for example more than one hundred passengers, for example more than one hundred and fifty passengers, or an equivalent amount of cargo.

According to a fifth aspect of the invention there is also provided a kit of parts for a bearing assembly in accordance with any other aspect of the invention. The kit may comprise two bushes, each bush having a flange. The flange may be located at one end of the bush. The kit may comprise a sleeve configured to provide an interference fit with the first and second bushes. The kit may comprise a bearing, for example a moving element bearing, for example a cylindrical roller bearing. The bearing may be configured to be received in the sleeve or the first and second bushes. The kit may comprise further bushes configured to be received in a recess formed in the moving element bearing. The kit may comprise a sealant, for example a structural sealant, for preventing the ingress of moisture between the outer surface of the bush and the inner surface of the through-hole, the inner surface of a bush and the outer surface of a sleeve, the inner surface of a sleeve and the outer surface of a moving element bearing, or other bearing element. The sealant may also provide an adhesive bond between one or more of those elements of the assembly.

According to a sixth aspect of the invention there is provided a method of installing a bearing assembly in a through-hole in a composite material, the bearing assembly comprising a first bush and a second bush, each of the first and second bushes having a flange. The method may comprise inserting a portion of the first bush into one end of the through-hole such that the flange is adjacent to one side of the material. The method may comprise inserting a portion of the second bush into the other end of the through-hole such that the flange is adjacent to the other side of the material. The method may comprise, once the bushes have been inserted in the through-hole, fixing the first and second bushes together such that the flanges can act to constrain the movement of both bushes.

Inserting the first bush into one end of the through-hole may comprise moving the first bush in a first direction. Inserting the second bush into the other end of the through-hole may comprise moving the second bush in a second direction, opposite to the first direction. The method may comprise inserting the first and second bushes into the through-hole by hand.

The step of fixing the first and second bushes together may comprise inserting a sleeve into the through-hole and through the first and second bushes. The sleeve may be inserted such that an interference fit is created between the sleeve and the bushes. The interference fit between the sleeve and the bushes may be created in a number of ways. The step of inserting the sleeve may comprise press-fitting or freeze-fitting the sleeve into the first bush and the second bush. The method may comprise pressing or freeze fitting the sleeve into the through-hole such that the sleeve compresses the first and/or second bushes against an inside surface of the through-hole. It will be appreciated that press-fit refers to a process in which the interference fit is created using mechanical force. The freeze-fit process comprises cooling a component, for example by dipping a component in liquid nitrogen, in order to shrink that component, the component can then be inserted into a recess where it will then expand as it warms back up to ambient temperature. These processes which produce good engagement between the components involved can be used because the composite material is protected from the forces involved by the presence of the bushes.

The sleeve may be inserted such that a portion of the sleeve extends beyond the end of the bush on each side of the composite material. The step of fixing the first and second bushes together may further comprise flattening, for example swaging, the ends of the sleeve such that each end of the sleeve extends over a portion of the adjacent bush, for example the flange of the bush. Thus, the portion of the sleeve that has been so deformed may act to retain the first and second bushes, and/or prevent axial movement of the first and second bushes relative to each other and the sleeve.

At least one of the first and second bushes may comprise a male interlock feature and the other of the first and second bushes may comprises a female interlock feature. The step of fixing the first and second bushes together may comprise rotating the first and second bushes relative to each other to insert the male interlock feature into the female interlock feature. The step of rotating the first and second bushes may cause a deformation of at least part of the male and/or female interlock feature such that once the male and female features are engaged, unlocking is resisted. A step of disconnecting the first and second bushes may comprise rotating the first and second bushes relative to each other to disengage one or more interlocking features.

The step of fixing the first and second bushes together may comprise deforming a portion of at least one of the first and second bush. The method may comprise deforming the first and/or second interlock features by rotating the bushes relative to each other.

It may be that at least one of the first and second bushes is threaded and the step of fixing the first and second bushes together comprises screwing one of the first and second bush into the other of the first and second bush. It may be that the first or second bush comprises a male screw thread, but the other of the first and second bush does not include a corresponding female screw thread. In that case, the step of screwing the first and second bush together may comprise using the one of the first and second bushes having the male screw thread to create a female screw thread in a surface of the other of the first and second bushes. Thus, the first and/or second bush may comprise a self-tapping screw thread.

The method may comprise a step of applying a sealant, for example a structural sealant, between the outer surface of the first and/or second bushes and an inner surface of the through-hole. The method may comprise a step of apply a sealant between an inner surface of the first and/or second bushes and an outer surface of the sleeve or a bearing mounted directly in the first and/or second bushes.

The method may comprise a step of mounting a moving element bearing within the sleeve.

According to an seventh aspect of the invention, there is provided a method of repairing a bearing assembly in accordance with any other aspect of the invention. The method may comprise the step of removing, for example pushing or pulling out, a moving element bearing mounted in the sleeve. The method may comprise the step of removing, for example pushing out or pulling out, a sleeve mounted in the bushes. The method may comprise replacing the sleeve by inserting a new sleeve into the bushes as described above. The method may comprise replacing the bearing by mounting a new bearing onto the sleeve or bushes as described above. The method may comprise removing a sleeve and/or a bearing from a first and/or second bush and replacing the sleeve and/or bearing by mounting a new sleeve and/or bearing into the same first and/or second bush. Thus, it may be that the first and/or second bushes remain in place in the composite material during the repair. The risk of damaging the composite material may therefore be reduced as the bushes protect the composite material from the risk of damage.

In the case that a sleeve is present, the step of removing the sleeve may comprise removing the portion(s) of the sleeve that extends over the face(s) of the bush(es), for example the rim or lip. For example, the sleeve may comprise a rim or lip extending over a portion of the flange on each side of the composite material. The method may comprise removing the rim or lip, for example cutting or grinding off the rim or lip, to release the sleeve from the first and second bushes.

The method may comprise rotating the first and second bushes to disengage the interlocking features (as described above) and thereby allow axial movement of the first and second bushes relative to each other.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic view of an aircraft including a bearing assembly according to a first embodiment of the invention;

FIG. 2 shows parts of the bearing assembly of the first embodiment;

FIGS. 3(a) and 3(b) show a cross-section and view from below, respectively, of the bearing assembly of the first embodiment;

FIGS. 4(a) to 4(e) show the bearing assembly of the first embodiment at different stages of the assembly process;

FIG. 5 shows a portion of a bearing assembly in accordance with a second example embodiment;

FIGS. 6(a) and 6(b) show a schematic close-up cross-section of part of the bearing assembly of the second embodiment in 6(a) a disengaged and 6(b) an engaged configuration; and

FIG. 7 shows two bushings for use in a bearing assembly in accordance with a third example embodiment.

### DETAILED DESCRIPTION

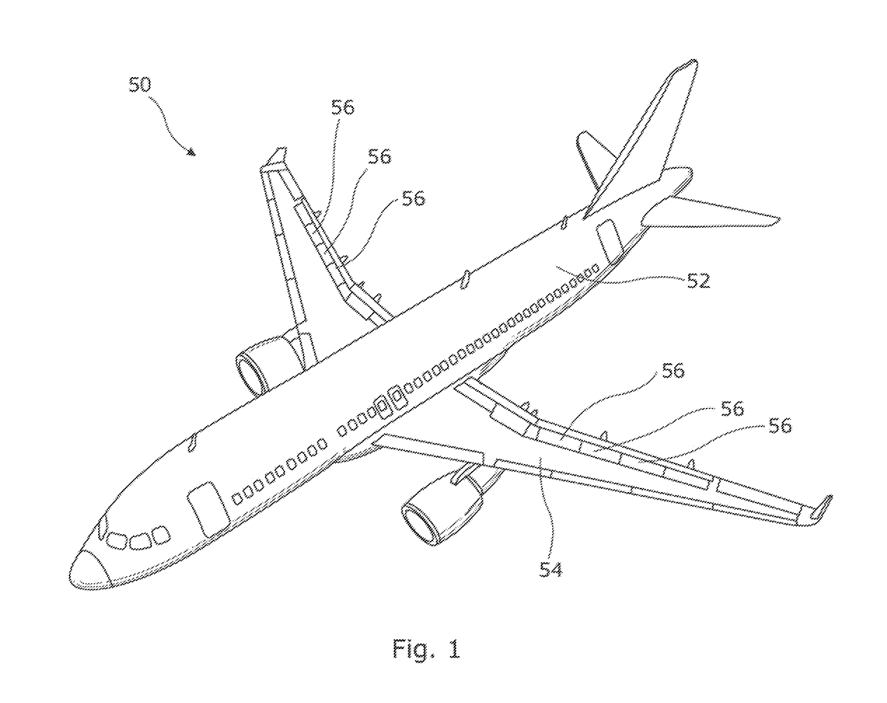

FIG. 1 shows a commercial, fixed wing, passenger aircraft 50 including a fuselage 52 and wings 54. A plurality of spoilers 56 are spaced apart along the span of each wing 54. Each spoiler 56 is mounted to the aircraft via a bearing assembly in accordance with a first example embodiment (not visible in FIG. 1) located in a lug formed on the aircraft structure.

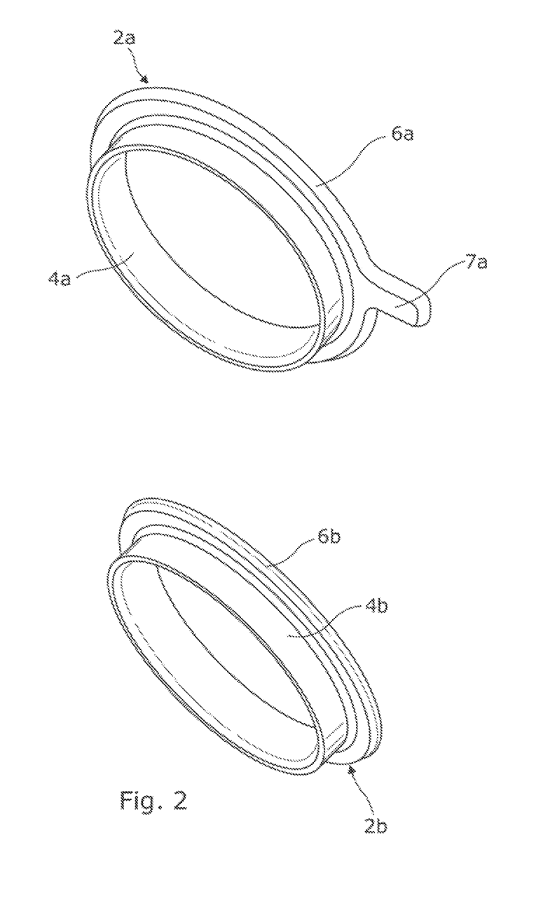

FIG. 2 shows a close up of a first bush 2a and a second bush 2b for use in the bearing assembly 1. The first bush 2a has a tubular body 4a which is substantially circular when viewed in cross-section with a flange 6a extending around the perimeter of the tubular body 4a at one end. The flange 6a has a tab 7a extending radially from it. The second bush 2b has a tubular body 4b which is substantially circular when viewed in cross-section with a flange 6b extending around the perimeter of the tubular body 4b at one end. The second bush 2b does not include a tab.

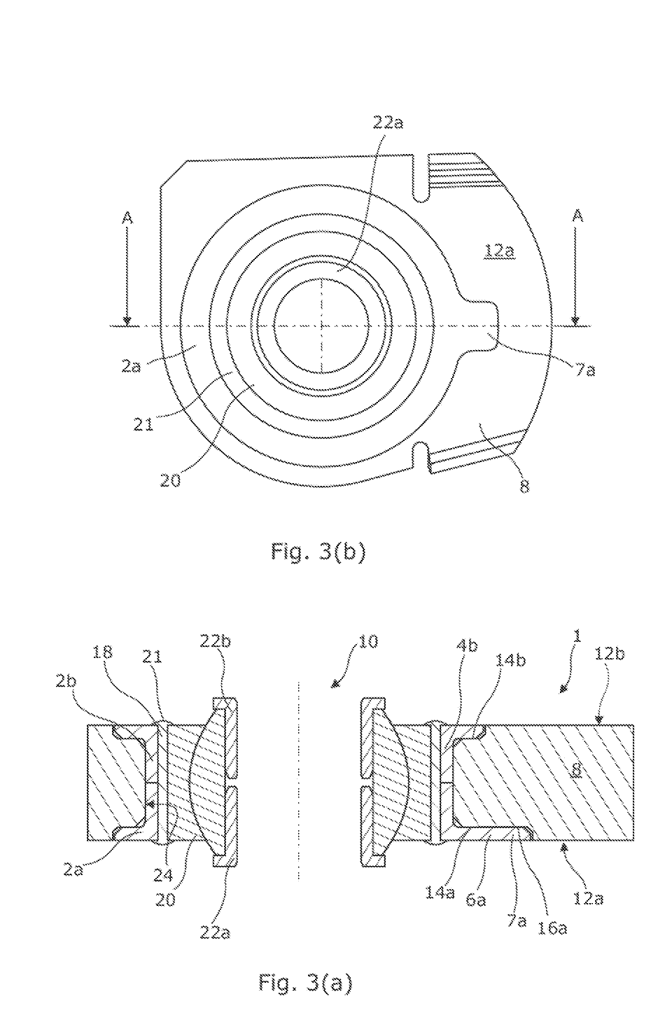

FIG. 3(a) shows a schematic cross-section view of the bearing assembly 1 of the first example embodiment when installed in the lug 8, which is made from a carbon-fibre composite material. The lug 8 comprises a through-hole 10 defined by an inner surface 24. The through-hole 10 extends between a first, lower, surface 12a and a second, upper, surface 12b of the lug 8 with the bushes 2a, 2b mounted co-axially therein. A counter-bore 14a, 14b is coaxial with the through-hole 10 at each end. The tubular body 4a of the first bush 2a is received in one end of the through-hole 10 (the lower end of the hole 10 in FIG. 3) and the flange 6a lies in the counter-bore 14a such that the outer surface of the flange 6a is substantially flush with the first surface 12a. The tab 7a is located in a recess 16a extending radially outwards from the counter-bore 14a. The tubular body 4b of the second bush 2b is received in the other end of the through-hole 10 (the upper end of the hole 10 in FIG. 3) with the outer surface of the body 4a adjacent the inner surface 24 of the through-hole 10. The flange 6b of the second bush 2b lies in a counter-bore 14b such that the outer surface of the flange 6b is substantially flush with the second surface 12b. The ends of the bushes 2a, 2b without the flanges 6a, 6b abut each other. A sleeve 18 extends through the through-hole 10 and both bushes 2a, 2b, concentric with the bushes 2a, 2b and with the outer surface of the sleeve 18 adjacent the inner surface of tubular body 4a, 4b of each bush 2a, 2b. A spherical bearing 20 mounted within the sleeve 18 is concentric with the sleeve 18 and the bushes 2a, 2b and extends through the depth of the through-hole 10. Two inner bushes 22a, 22b are mounted within the spherical bearing 20, at either end of the through hole 10 and concentric with it. At either end, the sleeve 18 extends radially over the bush 2a, 2b located around the sleeve 18 and the spherical bearing 20 located inside the sleeve to form a rim 21. A layer of sealant (not shown in FIG. 3) extends between each bush 2a, 2b and the inner surface 24 of the through-hole 10. The edge at the transition between each of the outer surfaces 12a, 12b and corresponding counter-bore 14a, 14b is chamfered. The edge between the bottom of each counter-bore 14a, 14b and the inner surface 24 of the through-hole 10 is also chamfered. The corresponding corners on the flanges 6a, 6b of the bushes 2a, 2b are also chamfered. In some example embodiments the sleeve 18 is made from Aluminium, and the bush elements 2a, 2b from steel. In use, a rod connected to the spoiler 56 is inserted in the through-hole 10 between inner bushes 22a, 22b, and can rotate relative to the lug 8 due to the presence of spherical bearing 20.

FIG. 3(b) shows a view from below of the assembly of FIG. 3(a). In order from the centre outwards the elements are as follows: inner bush 22a, bearing 20, sleeve 18, of which the rim 21 is visible in FIG. 3(b) and first bush 2a. The line labelled A in FIG. 3(b) denotes the plane along which the cross-section of FIG. 3(a) is taken.

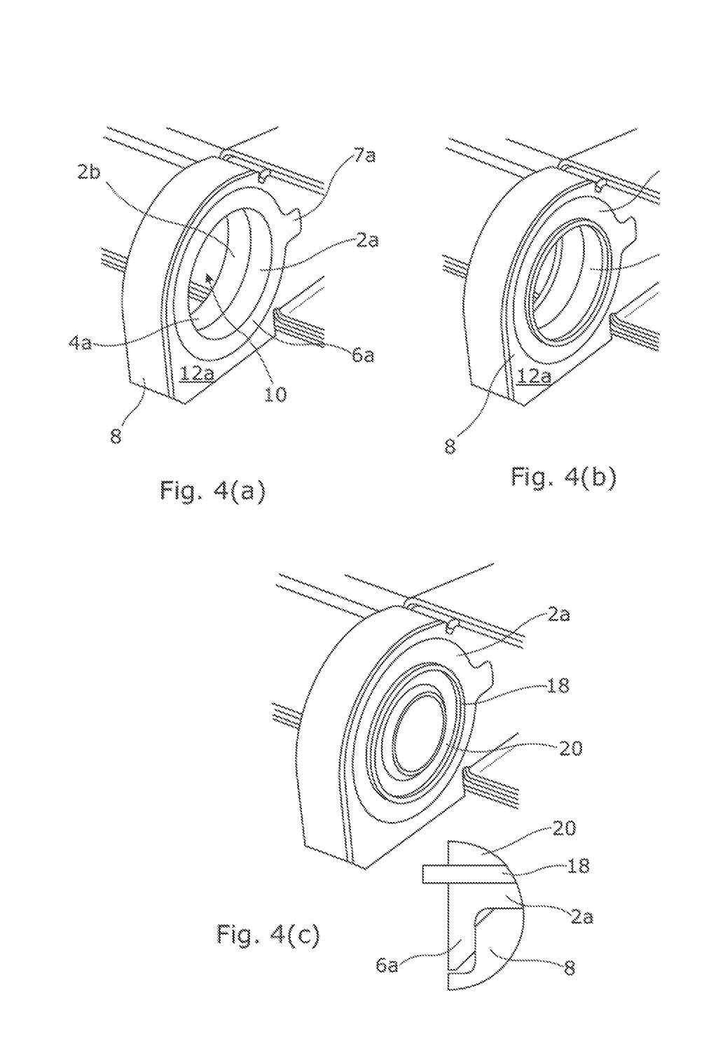

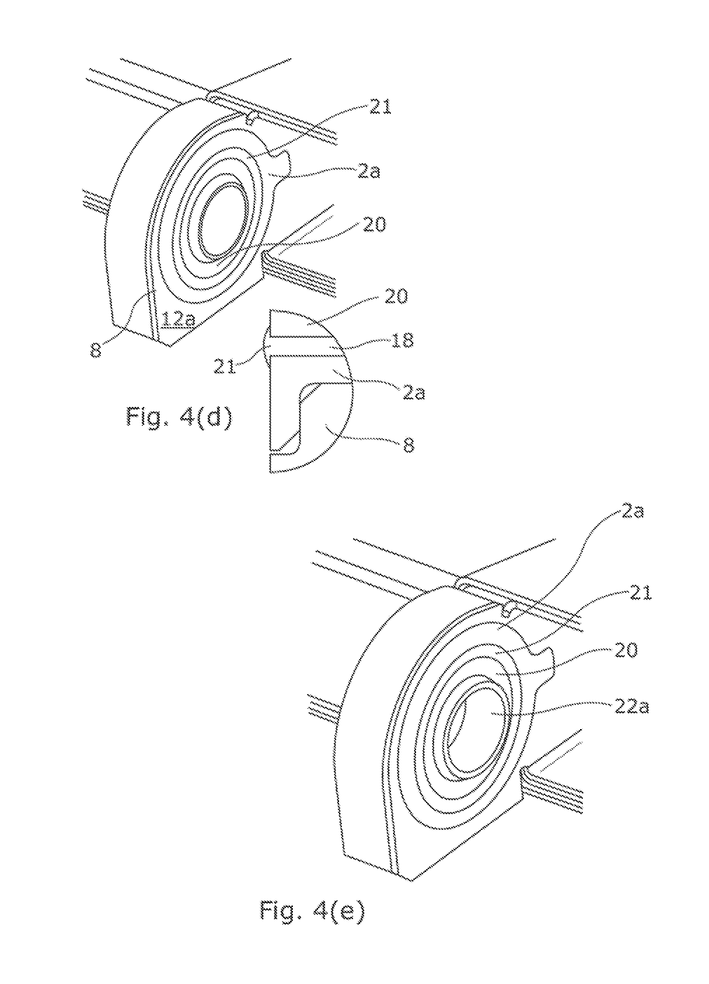

FIG. 4(a) to (e) show the bearing assembly of the first embodiment at different stages of the assembly process. In FIG. 4(a) the tubular body 4a of the first bush 2a is located in the right-hand end of the through-hole 10 formed in the lug 8 with the flange 6a and tab 7a received in the counter-bore 14a and the recess 16a respectively. The tubular body 4b of the second bush 2b is located in the left-hand end of the through-hole 10 with the flange 6b received in the counter-bore 14b (not visible in FIG. 4). When installed in the lug 8 as shown in FIG. 4(a) the longitudinal axis of each bush is horizontal. In FIG. 4(b) the sleeve 18 is located within the through-hole 10 and extends through bush 2a and 2b. The ends of the sleeve 18 protrude beyond the end of the through-hole 10 past the outer face of the surfaces 12a, 12b and the bushes 2a, 2b. In FIG. 4(c) a spherical bearing 20 has been inserted into the sleeve 18. The ends of the sleeve 18 protrude beyond the outer surface of the bearing 20. The inset of FIG. 4(c) shows a cross-sectional close-up in the region of the flange 6a. In FIG. 4(d) the ends of the sleeve 18 are deformed relative to FIG. 4(c) such that each end comprises a rim 21 that extends over the outer surface of the adjacent bush 2a or 2b and the bearing 20. The inset of FIG. 4(d) shows a cross-section close-up in the region of the flange 6b, the end of the sleeve 18 now comprise a domed rim 21 that extends radially over the surface of the bearing 2 and the flange 6a. In FIG. 4(e) another bushing 22a is received in the through-hole of the spherical bearing 20.

In use, to assemble the bearing assembly 1 the first bush 2a is inserted from the right-hand side of through-hole 10 and the second bush element 2b is inserted from the left-hand side of through-hole 10. In order to avoid damaging the composite material which defines the through-hole 10 the bushes 2a, 2b are sized to fit in the through-hole without the need for application of a significant force and may be inserted by hand. At the end of this step the assembly is in the configuration seen in FIG. 4(a). The sleeve 18 is then press fit into the two bushes 2a, 2b. In other examples, the sleeve 18 may be freeze-fit into the bushes 2a, 2b. The freeze-fit process comprises dipping a component in liquid nitrogen in order to shrink that component, the component can then be inserted into a recess where it will then expand as it warms back up to ambient temperature. At the end of this step of the assembly is in the configuration seen in FIG. 4(b). Once the sleeve 18 is installed a spherical bearing 20 is press-fit into the sleeve 18. At the end of this step, the assembly is in the configuration seen in FIG. 4(c). The protruding ends of the sleeve 18 are then swaged which flattens the ends of the sleeve 18 across the outer surfaces of the bush elements 2a, 2b and the bearing 20. The combination of the push-fit of the sleeve 18 into the bushes 2a, 2b and the swaging prevents the bushes 2a, 2b moving axially relative to each other and the sleeve 18. The flanges 6a, 6b at either end prevent the bearing 1 from coming out of the through-hole 10. The bushes 2a, 2b and sleeve 18 therefore effectively form a plain bearing securely located in the through-hole 10, with the inner surface of the sleeve 18 forming the bearing surface. The swaging of the sleeve 18 also holds the bearing 20 in place. Further bushes 22a, 22b can then be inserted into the bearing 20. It will be appreciated that other bearing elements apart spherical bearing 20 and inner bushes 22a, 22b can also be mounted inside sleeve 18, or it may be that no further bearing elements are required. Methods in accordance with the present example embodiment may allow for the provision of a bearing assembly in a composite material, while reducing the risk of damage to the composite material by avoiding the need to apply large amounts of force directly onto the composite material; the bushes are pushed in with low force and then protect the composite material from the forces applied during the press-fit of the sleeve. The presence of tab 7a in recess 16a prevents the bushes 2a, 2b, rotating in the through-hole 2 and therefore reduces the risk of migration.

When it is time to carry out maintenance of the bearing assembly 1, the rim 21 can be cut off, and the bearing 20 and sleeve 18 pulled out. A new sleeve 18 and bearing 20 may then be installed within the original bushes 2a, 2b, using the same procedure as described above. The use of bearing assemblies 1 in accordance with the present example embodiment may therefore reduce the risk of damage to the composite material during maintenance as the first bush 2a, and second bush 2b can remain in place while elements with a shorter lifespan, such as spherical bearing 20 are swapped out.

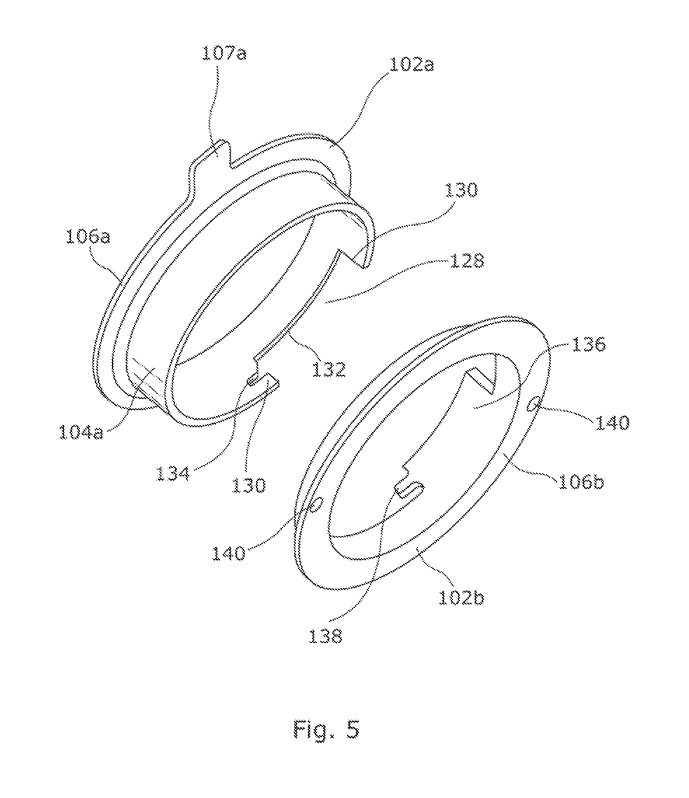

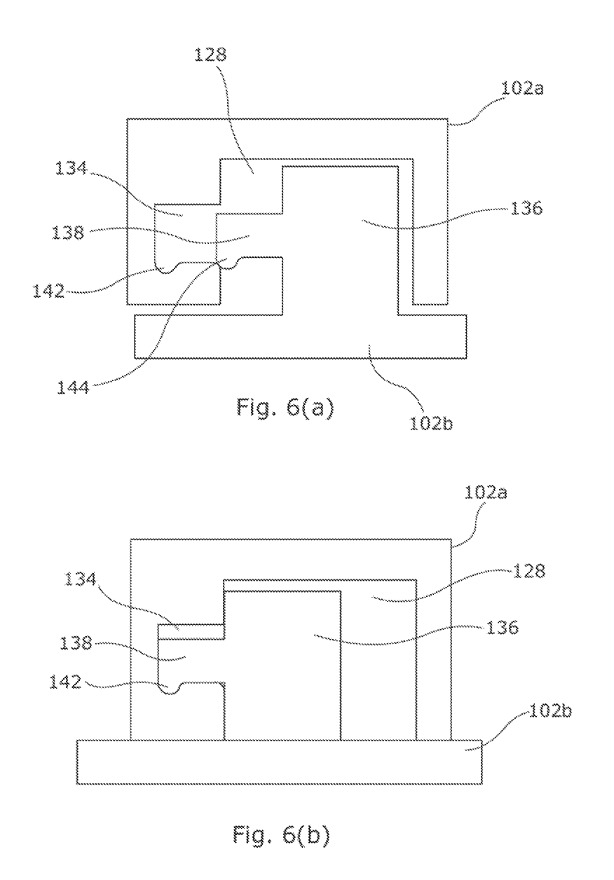

FIG. 5 shows a portion of a bearing assembly in accordance with a second example embodiment. Like reference numerals denote like elements and only those aspects of the present embodiment which differ with respect to the first embodiment will be discussed here. In contrast to the first embodiment, the assembly 101 of the second embodiment does not include a sleeve, and instead the first and second bushes 102a, 102b are interlocked to prevent the elements moving axially relative to each other. In the second embodiment, the first bush 102a includes a main recess 128 in the tubular body 104a. The recess 128 extends axially inwards from the end of the bush 102a opposite the flange 106a and around a portion of the circumference and is defined by two side walls 130 extending axially along a portion of the length of the tubular body 4a and an end wall 132 extending circumferentially around a portion of the body 4a. An interlocking channel 134 (shown in more detail in FIG. 6) is formed in the left-hand side wall 130 and extends around a portion of the circumference of the body 4a, the circumferential and longitudinal extend of the channel 134 being very much less than that of the main recess 128. The second bush 102b comprises a protrusion 136 extending in the axial direction from the end of the bush 2b opposite the flange 6b. A resilient arm 138 extends in a circumferential direction from the left-hand side of the protrusion 136. Two equidistantly spaced tool access holes 140 are formed in the face of the flange 106b.

FIGS. 6(a) and (b) show a schematic close-up of the recess 128 and the protrusion 136 in the disengaged and engaged configuration respectively. The interlocking channel 134 in the left-hand side wall of the recess 128 appears rectangular when viewed in cross-section in FIG. 6(a) apart from a groove 142 formed in the bottom of the channel 134. A lip 144 is formed on the underside of the resilient arm 138. In the disengaged position of FIG. 6(a) the protrusion 136 is received in the main recess 128 towards the right-hand side of the recess 128 such that the arm 138 is spaced apart from the interlocking channel 134, with the lip 144 just below the level of the bottom of the channel 134. The bushes 102a, 102b are therefore free to move axially relative to each other when configured as shown in FIG. 6(a). In the engaged position of FIG. 6(b) the protrusion 136 has moved to the left relative to the recess 128 so that the arm 138 is fully received in the channel 134 and the lip 144 is received in the groove 142. The geometry of recess 128, channel 134, arm 138 and protrusion 136 means that axial movement of the first and second bush 102a, 102b relative to each other is prevented.

In use, the first and second bush 102a, 102b are inserted into a through-hole in a lug (not shown in FIG. 6) such that the flanges 106a, 106b rest against the outer surfaces 112a, 112b respectively, and the protrusion 134 and recess 128 are in the configuration shown in FIG. 6(a). The tab 107a is located in a recess in the surface 112a such that the first element 102a is not free to rotate. A u-shaped hex key (also known as an Allen® key) is inserted into tool access holes 140 in the second bush 102b, to rotate the second bush 102b relative to the first bush 102a. As the protrusion 134 moves leftward across the recess 128 the resilient arm 138 deforms upwards allowing the lip 144 (and the rest of the arm above it) to pass into the channel 134. The left-ward movement continues until the elements 102a, 102b reach the configuration shown in FIG. 6(b). The resilient nature of the arm 138 allows the arm 138 to deform as the bushes 102a, 102b are brought into a locking engagement, while the lip 144 located in groove 142 resists the unlocking of the bushes 102a, 102b. The first and second bushes 102a, 102b also move closer together axially. In order to further secure the interlock between the two bush elements 102a, 102b a sealant may be inserted into the gap formed between the right-hand side of the protrusion 134 and the right-hand side wall 130 of the recess 128 when the assembly is in the configuration of FIG. 6(b). Thus, assemblies in accordance with the second example embodiment may allow for the provision of a plain bearing surface in a composite material while reducing the amount of force exerted on the composite material (and therefore the risk of damage to the material) in comparison to prior art techniques, because instead of a push or freeze fit a form interlock is used. The inner surface of the bushes 102a, 102b forms the bearing surface and additional elements such as cylindrical bearings may be located therein as discussed above with reference to the first embodiment.

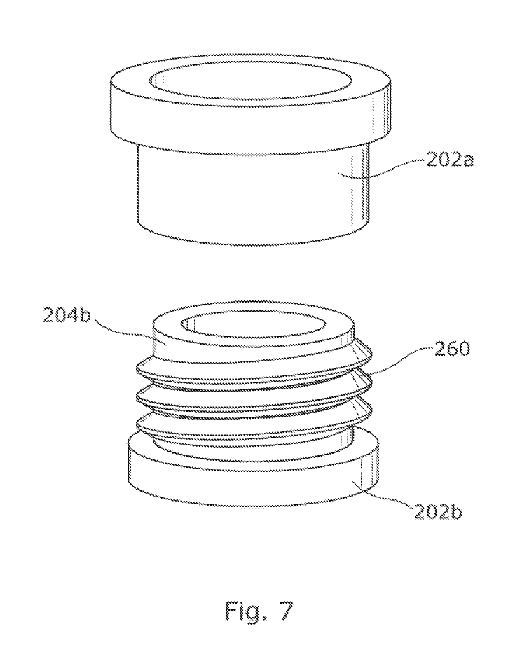

FIG. 7 shows two bushings 202a, 202b for use in a bearing assembly in accordance with a third example embodiment. Only those elements of the present embodiment which differ with respect to the second embodiment will be discussed here. Like reference numerals denote like elements. The bushes of the third embodiment do not include a protrusion or main recess as in the second embodiment. Instead the outer surface of the tubular body 204b of the second bush 202b has a (male) screw thread 260 extending along a portion of its length. In some embodiments the inner surface of the tubular body 204a of the first bush 202a may have a corresponding internal (female) screw thread, or the inner surface of the tubular body may not have a thread, in which case the end of the tubular body may comprise self-tapping features, for example a flute and/or a cutting edge, that allow the second bush 202b to cut into the inner surface of the first element 202a.

In use, the first bush 202a is inserted in the through-hole with the tab 207a (not visible in FIG. 7) received in a tab recess such that the first bush 202a cannot rotated relative to the through-hole. The second bush 202b is then screwed into the first bush 202a, and the inner surface of the second bush 202b forms the bearing surface for the bearing assembly. Alternatively, additional elements such as cylindrical bearings may be located inside the second bush as discussed above with reference to the first embodiment. Assemblies in accordance with the third example embodiment may allow for the provision of a plain bearing surface in a composite material while reducing the amount of force exerted on the composite material (and therefore the risk of damage to the material) in comparison to prior art techniques. The screw thread of the third embodiment may be a mechanically simple yet effective way of doing this.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The above embodiments have been described with reference to a spoiler on an aircraft, it will be appreciated that the bearing assembly may be used to mount other aircraft control services. While the embodiments described above include bushes having similar axial lengths it will be appreciated that first and second bushes having different lengths may be used. In some circumstances, it may be advantageous to use the bearings described above in non-composite, for example metallic, structures. The bearing assemblies described above may also find use in non-aircraft applications.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of installing a bearing assembly in a through-hole in a composite material on an aircraft, the bearing assembly comprising a first bush and a second bush, each of the first and second bush having a flange, the method comprising the steps of:
inserting a portion of the first bush into one end of the through-hole such that the flange of said bush is adjacent to one side of the material;
inserting a portion of the second bush into the other end of the through-hole such that the flange of said bush is adjacent to the other side of the material; and then
fixing the first and second bushes together such that the flanges constrain the axial movement of both bushes relative to the through-hole.

2. A method according to claim 1, wherein the step of fixing the first and second bushes together comprises press-fitting or freeze-fitting a sleeve through both the first bush and the second bush.

3. A method according to claim 2, wherein the sleeve is inserted such that portion of the sleeve extends beyond the flange on each side, and the step of fixing the first and second bushes together further comprises swaging the ends of the sleeve such that each end of the sleeve extends over a portion of the adjacent flange.

4. A method according to claim 1, wherein at least one of the first and second bushes is threaded and the step of fixing the first and second bushes together comprises screwing one of the first and second bush into the other of the first and second bush.

5. A method according to claim 1, wherein at least one of the first and second bushes comprises a male interlock feature and the other of the first and second bushes comprises a female interlock feature and the step of fixing the first and second bushes together comprises rotating the first and second bushes relative to each other to bring the male and female features into engagement and thereby limit an axial movement of the bushes relative to each other.

6. A method according to claim 5, wherein the step of rotating the first and second bushes causes a deformation of at least part of the male and/or female interlock feature such that once the male and female features are interlocked, unlocking is resisted.

7. A method according to claim 1, further comprising a step of applying a sealant between the outer surface of the first and/or second bushes and an inner surface of the through-hole.

8. A method of servicing a bearing assembly received in a through-hole in a composite material on an aircraft, the bearing assembly comprising a first bush and a second bush, each of the first and second bushes having a flange, a portion of each bush is located in the through-hole with the flange of one of the first and second bushes on one side of the composite material and the flange of the other one of the first and second bushes on the other side of the composite material, the first and second bushes being fixed together such that the flanges together limit axial movement of the first and second bushes relative to the through-hole, the bearing assembly further comprising one or more bearing elements mounted on the first and second bushes, the method comprising the steps of removing said bearing element and installing a new bearing element, and maintaining the first and second bushes in the through-hole during the steps of the method.

9. A method according to claim 8, wherein the bearing element is mounted on a sleeve inserted through the first and second bushes, and the sleeve comprises a rim extending over a portion of the flanges at either end, the method comprising the step of removing the rim of the sleeve to release the sleeve and then replacing the sleeve with a new sleeve before installing the new bearing element.

10. A bearing assembly configured for installation in a through-hole in a composite material on an aircraft, the bearing assembly comprising a first bush and a second bush, each of the first and second bushes having a flange, the first and second bushes being held together such that, in use, when the bearing is installed in the through-hole with the flanges of the first and second bushes on opposite sides of the material the flanges limit the axial movement of the bushes relative to the through-hole.

11. A bearing assembly according to claim 10, further comprising a sleeve configured to be received in a recess in each of the first and second bushes in an interference fit such that the sleeve holds the first and second bushes together.

12. A bearing assembly according to claim 11, wherein the sleeve extends through each of the first and second bushes and comprises a rim at each end to limit axial movement of the first and second bushes relative to the sleeve.

13. A bearing assembly according to claim 10, wherein at least one of the first or second bushes comprises an interlock feature configured such that rotation of the first and second bushes relative to each other causes the interlock feature to engage with the other of the first or second bushes to limit axial movement of the first and second bushes relative to each other.

14. A bearing assembly according to claim 13, wherein the interlock feature comprises a screw thread such that rotation of the first and second bushes relative to each other causes the first and second bushes to be screwed together.

15. A bearing assembly according to claim 13, wherein the one of the first and second bush comprises a male interlock feature comprising a protrusion, and the other of the first and second bush comprises a female interlock feature comprising a recess, the protrusion and recess being configured such that when the protrusion is engaged with the recess axial movement of the first and second bush relative to each other is limited.

16. A bearing assembly according to claim 15, wherein the bush assembly is configured such that rotation of the first and second bushes relative to each other causes the protrusion to be move into engagement with the recess.

17. A bearing assembly according to claim 13, wherein the first and second bushes are configured such that rotation of the bushes relative to each other causes a deformation of the interlock feature.

18. A bearing assembly according to claim 10, wherein at least one of the first or second bushes comprises a tab extending radially from the flange such that, in use, the tab can be received in a corresponding recess in the surface of the composite material to prevent rotation of the bush in the through-hole.

19. A bearing assembly in accordance with claim 10, said bearing assembly being mounted in a through-hole in a composite lug on an aircraft.

20. A bearing assembly according to claim 19, wherein the lug comprises a counter-bore formed co-axially with the through-hole in at least one surface of the composite material, and a flange of the bearing assembly is received in the counter-bore such that an outer surface of the flange is substantially flush with the outer surface of the composite material.

21. A kit of parts configured for forming a bearing assembly in accordance with claim 10, the kit comprising two bushes, and wherein each bush comprising a flange.
